(19) United States
(12) Patent Application Publication
(10) Pub. No.: US 2002/0105892 A1
(43) Pub. Date: Aug. 8, 2002

(54) Optical pickup device

(76) Inventors: Seiji Onishi, Matsuyama-shi (JP); Tetsu Tanaka, Ehime (JP)

Correspondence Address: WENDEROTH, LIND & PONACK, L.L.P., 2033 K STREET N. W., SUITE 800, WASHINGTON, DC, 20006-1021, US

(21) Appl. No.: 10/018,686

(22) PCT Filed: Jun. 6, 2001
(86) PCT No.: PCT/JP01/04760

(30) Foreign Application Priority Data
Jun. 6, 2000 (JP) 2000-169511
Jun. 30, 2000 (JP) 2000-199188

(51) Int. Cl. G11B 7/135

(52) U.S. Cl. 369/112.17; 369/121; 369/112.24; 369/118

(57) ABSTRACT

The present invention has for its object to provide a compact and simplified optical pickup device which secures sufficient quantity of converged light required for recording and reproducing onto/from respective optical disks, can obtain required imaging magnification of respective optical systems, and does not generate performance degradation at lens shift, when recording or reproduction is performed onto/from optical disks with different base material thickness by plural optical systems of a single optical pickup device.

A first light source and second light source which emit light beams with different wavelength corresponding to plural kinds of optical information recording media, a beam splitter as a synthesizing means, a collimator lens as an optical converting means, and an objective lens as a converging means are equipped, and a light path length converting means such as a prism mirror, which is made of material having high refractive index, for lengthening light path length (air reduction length) is provided between the synthesizing means and the converging means in a state where the first light source is located nearer to the optical converting means than a back focus thereof is and the second light source is located farther from the optical converting means than a back focus thereof is, thereby to making the synthesizing means close to the converging means.

### TECHNICAL FIELD

The present invention relates to an optical pickup device and, more particularly, to one which performs data recording or reproduction onto/from plural optical disks with different base material thickness according to plural laser light sources by a single optical pickup.

### BACKGROUND ART

With recent practical application of a short-wavelength red laser, there is developed a high-capacity DVD which employs a light source with 620-680 nm wavelength to enhance its recording density, while a CD, recordable CD-R or the like as a conventional optical information recording medium (optical disk) employs a light source with 770-830 nm wavelength.

An optical pickup device for such new optical disk, a DVD, requires compatibility between the DVD whose base material is 0.6 mm thick and a CD whose base material, largely different from the former, is 1.2 mm thick, and thus various examinations are made. One of them is the “OPTICAL PICKUP DEVICE” disclosed in Japanese Published Patent Application No. Hei. 10-199021.

FIG. 3 is a block diagram illustrating a construction of the above-described conventional pickup device.

In FIG. 3, numeral 21 denotes a first semiconductor laser as a first light source for irradiation onto a first optical disk 24 in the form of a DVD, and its wavelength λ1 is 610-670 nm. Numeral 22 denotes a second semiconductor laser as a second light source for irradiation onto a second optical disk 24 in the form of a CD-R, and its wavelength λ2 is 760-830 nm.

Numeral 23 denotes a dichroic prism as a synthesizing means for making an optical axis of a light emitted from the first semiconductor laser 21 almost coincide with an optical axis of a light emitted from the second semiconductor laser 22, and numeral 60 denotes a lens having a positive refractive index as a converting means, which, being provided between the dichroic prism 23 and the second semiconductor laser 22, approximately equalizes divergence degree of the light of the first semiconductor laser emitted from the dichroic prism 23 with divergence degree of the light of the second semiconductor laser. Numeral 40 denotes a polarization beam splitter.

Numeral 30 denotes a converging means for converging a light emitted from the polarization beam splitter 40 onto the optical disk 24, which has a coupling lens 31 and an objective lens 32. Here, a collimator lens, which makes lights emitted form the dichroic prism 23 and the polarized beam splitter 40 parallel lights, is employed as the coupling lens 31 and an infinite objective lens 32, which converges the parallel lights onto the optical disk 24, is employed as the objective lens 32.

Further, a quarter wavelength plate 35 and a diaphragm 36 are provided in the converging means 30. The quarter wavelength plate 35 converts a light transmitted through the coupling lens 31 from a linear polarized light into a circularly polarized light, and the diaphragm 36 restricts the parallel luminous flux to a numerical aperture of the objective lens 32 on the side of the optical disk 24, which is required for reproduction of the optical disk 24.

Numeral 50 denotes a light receiving means, in which a light detector 51 detects distribution change of quantity of light reflected from the surface of the optical disk 24 through a cylindrical lens 52 which generates astigmatism, and focus detection, track detection, and reading of information are performed by an arithmetic processing circuit which is not shown.

Next, an operation of the so-constructed optical pickup will be described.

A light emitted from the first semiconductor laser 21 is incident on the dichroic prism 23, is bent by the dichroic prism 23 so that its optical axis coincides with an optical axis of a light emitted from the second semiconductor laser 22, is transmitted through the polarization beam splitter 40, and is incident on the converging means 30. In the converging means 30, the coupling lens 31 makes the lights emitted from the polarization beam splitter 40 parallel lights, the quarter wavelength plate 35 converts the parallel lights from linear polarized lights into circularly polarized lights, and the diaphragm 36 restricts the size of required aperture and converges and focuses the parallel lights onto the surface of the optical disk through the objective lens.

Next, the luminous flux reflected from the surface of the optical disk 24 is transmitted through the objective lens 32, the quarter wavelength plate 35, and the coupling lens 31 again and is incident on the polarization beam splitter 40. The light reflected at the polarization beam splitter 40 is received by the light receiving means 50. The light receiving means 50 detects distribution change of quantity of the light reflected from the surface of the optical disk 24 by the light detector 51, and performs focus detection, track detection, and reading of information by the arithmetic processing circuit which is not shown.

Further, a luminous flux emitted from the second semiconductor laser 22 has its divergence degree converted by the lens 60 as a converting means, is transmitted through the dichroic prism 20 and the polarization beam splitter 40, and is incident on the converging means 30 and transmitted through the coupling lens 31 and the quarter wavelength plate 35 to be a parallel luminous flux of a circularly polarized light. This luminous flux is focused by the diaphragm 36 and is converged onto the second optical disk 10 by the objective lens 32.

The luminous flux reflected from the second optical disk 24 is transmitted through the objective lens 32, the quarter wavelength plate 35, and the coupling lens 31 again, is incident on the polarization beam splitter 40 to be reflected, is given astigmatism by the cylindrical lens 52, and is incident on the light detector 51, thereby obtaining a read signal for information recorded on the optical disk 24 employing a signal outputted from the light detector 51.

Generally, however, when data are recorded onto the optical disk, a converged light quantity which is several times as large as that for reproduction is required, and thus the lens as a converting means for converting divergence degree of a light beam is required to be provided in one of light paths so as to enable acquisition of sufficient quantity of converged light for recording in the “OPTICAL PICKUP DEVICE” disclosed in the Japanese Published Patent Application No. Hei. 10-199021.

Therefore, a compact and simplified optical pickup device is hard to be designed for a pickup device for CD-R (recordable compact disk) which includes a circuit for controlling the quantity of output light from the light source.

Further, because an optical system employed for DVD reproduction is desired to have reproduction compatibility with DVD-RAM standard or the like, it is required to have a higher imaging magnification that is accomplished by an optical element between a laser light source employed for a DVD and an optical disk.

The present invention is made to solve the above-mentioned problems and has for its object to provide a compact and simplified optical pickup device for recording and reproduction onto/from optical disks with different base material thicknesses, which can secure sufficient quantity of converged light required for recording and reproduction onto/from respective optical disks.

Further, the present invention has for its object to provide an optical pickup device that causes no performance degradation at lens shifting.

### DISCLOSURE OF THE INVENTION

To solve the above-described problems, according to claim 1 of the present invention, there is provided an optical pickup device which comprises: a first light source for emitting a light beam with arbitrary wavelength; a second light source for emitting a light beam with wavelength different from that of the first light source; a synthesizing means for making an optical axis of the light beam emitted from the first light source coincide with an optical axis of the light beam emitted from the second light source; a converging means for converging the light beam outputted from the synthesizing means onto an optical disk; and a detecting means for receiving the light beam reflected on the optical disk, in which optical disk device the synthesizing means is made close to the converging means, so as to drastically change imaging magnification as divergence degree of the light beam emitted from the first light source which is outputted from the synthesizing means and imaging magnification as divergence degree of a light source of the light beam emitted from the second light source which is outputted from the synthesizing means.

According to the optical pickup device in the present invention, a light path length converting means such as a prism mirror which is made of material having high refractive index for lengthening light path length (air reduction length) is provided between a beam splitter as the synthesizing means and an objective lens as the converging means, so that the synthesizing means can be made close to the converging means, and a compact design of an optical system itself is possible, whereby downsizing, weight saving, and thinning of the optical pickup device can be realized, random access and degree of mechanical freedom of the loading system are improved, and weight saving of a drive can be realized.

According to claim 2 of the present invention, the optical pickup device as defined in claim 1 includes: a converting means for converting the light beam outputted from the synthesizing means into parallel lights.

According to claim 3 of the present invention, in the optical pickup device as defined in claim 2, when a back focus of the converting means for the wavelength of the first light source is f1 and a back focus of the converting means for the wavelength of the second light source is f2, the first light source is located at a position nearer to the converting means than f1 is, while the second light source is located at a position farther from the converting means than f2 is.

According to the present invention, imaging magnification accomplished by optical elements of two light paths with different wavelength is drastically changed so as to decrease imaging magnification in the optical system for a CD-R, in which quantity of converged light on the recording surface of the optical disk is required to be increased, while to increase imaging magnification in a DVD optical system. Therefore, in the CD-R optical system, utilizing efficiency of light beams is enhanced to increase the quantity of converged light on the recording surface of the optical disk, thereby enabling high-speed recording, while reproduction of DVD-RAM or the like is favorable in the DVD optical system.

According to claim 4 of the present invention, in the optical pickup device as defined in any of claims 1 to 3, a light path length converting means for lengthening light path length of a light is provided between the synthesizing means and the converging means.

According to claim 5 of the present invention, in the optical pickup device as defined in claim 4, the light path length converting means is made of material having high refractive index.

According to claim 6 of the present invention, in the optical pickup device as defined in any of claims 1 to 5, when imaging magnification that is accomplished by an optical element between the first light source and the optical disk is M1 and imaging magnification that is accomplished by an optical element between the second light source and the optical disk is M2, 1.5≦M2/M1.

According to the present invention, the beam splitter as the synthesizing means is made closer to the objective lens as the converging means as well as the position of the first light source is corrected so as to improve converging degree on the recording surface of the optical disk sufficiently enough for recording and reproduction, and therefore the imaging magnification M1 accomplished by each optical element in a CD-R light path can be made smaller than the imaging magnification M2 in a DVD light path (1.5≦M2/M1), and it is possible to enhance utilizing efficiency of light beams as well as secure sufficient quantity of converged light for high-speed recording.

According to claim 7 of the present invention, the optical pickup device as defined in any of claims 1 to 6 further includes: an aperture diaphragm for moving with the converging means and converging a light beam spot of desired size onto the optical disks.

According to the present invention, a desired optical spot can be formed on the optical disk.

According to claim 8 of the present invention, in the optical pickup device as defined in any of claims 1 to 7, when imaging magnification of the converging means with respect to the first light source is made m1, the following conditional expression is met: |m1|≦0.068.

According to the present invention, the CD-R optical system is made to have finite conjugate configuration much closer to infinite conjugate configuration, and therefore it is not likely to cause a state change of an incident light which is input into the objective lens by lens shifting and deterioration in off-axis aberrations generated at the lens shift does not easily exert an influence, resulting in prevention of performance degradation.

According to claim 9 of the present invention, in the optical pickup device as defined in any of claims 1 to 8, when numerical aperture on the side of the optical disk corresponding to the combination of the first light source and the optical disk is made NA1, and numerical aperture on the side of the optical disk corresponding to the combination of the second and the optical disk is made NA2, and when the imaging magnification of the converging means for the first light source is m1, and imaging magnification of the converging means for the second light source is m2, the following conditional expressions are met: NA1 <NA2,|m2|≦|m1|.

According to the present invention, it is possible to reduce the imaging magnification accomplished by an optical element of the CD-R optical system as well as increase the imaging magnification accomplished by an optical element of the DVD optical system, whereby imaging magnification required for respective optical systems can be obtained.

According to claim 10 of the present invention, in the optical pickup device as defined in any of claims 1 to 9, when wavelength of the light beam emitted from the first light source is made λ1, and wavelength of the light beam emitted from the second light source is made λ2, 760 nm≦λ1≦810 nm, 620 nm≦λ2≦680 nm.

According to claim 11 of the present invention, in the optical pickup device as defined in any of claims 1 to 10, the light beams as divergent lights emitted from the first and second light sources are incident on the synthesizing means, thereby scattering a reflected light on the surface of the synthesizing means.

According to the present invention, light beams as divergent beams emitted from the first and second light sources are incident on the beam splitter as the synthesizing means, whereby a reflected light is scattered on the surface of the beam splitter, so that interference between the light beams emitted from the first and second light sources and a returned light from the optical disk can be reduced.

### BRIEF DESCRIPTION OF DRAWINGS

FIG. 1 is a schematic diagram exemplifying an optical pickup device according to a first and third embodiments of the present invention.

FIG. 2 is a schematic diagram exemplifying an optical pickup device according to a second embodiment of the present invention.

FIG. 3 is a schematic diagram exemplifying an optical pickup device according to a prior art.

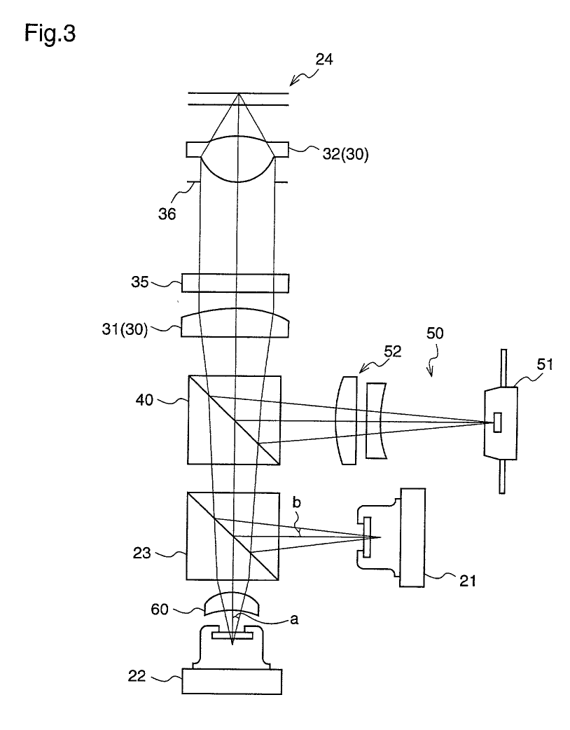

### BEST MODE TO EXECUTE THE INVENTION

Hereinafter, embodiments applying the present invention will be described with reference to figures. In the following description of each embodiment, a first optical disk is an optical disk in the form of a CD-R with 1.2 mm base material thickness and a second optical disk is an optical disk in the form of a DVD with 0.6 mm base material thickness.

Further, a first light source is a semiconductor laser for a CD-R and wavelength λ1 of a light beam emitted therefrom is 760-810 nm and a second light source is a semiconductor laser for a DVD and wavelength λ2 of a light beam emitted therefrom is 620-680 nm.

### EMBODIMENT 1

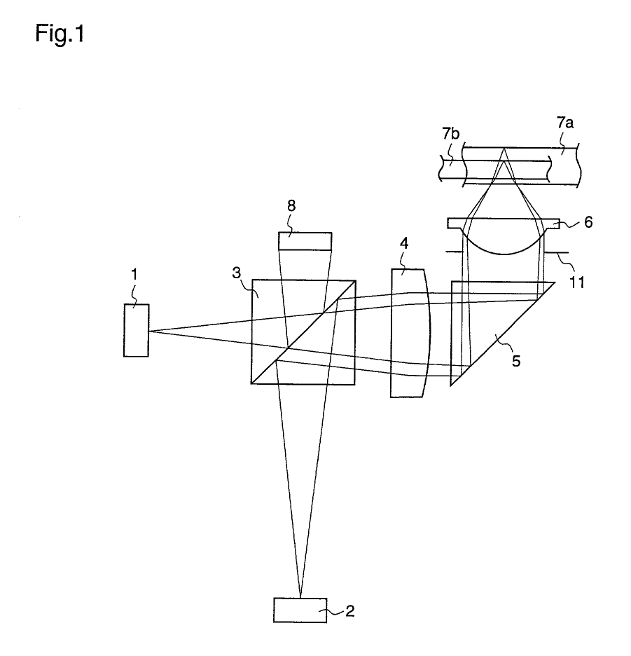

Hereinafter, an optical pickup device according to a first embodiment of the present invention will be described with reference to FIG. 1.

FIG. 1 is a schematic diagram exemplifying the optical pickup device according to the first embodiment of the present invention.

In the figure, the optical pickup device according to the first embodiment of the present invention comprises a hologram-detector combination laser unit 1 for a CD-R, a hologram-detector combination laser unit 2 for a DVD, a beam splitter 3, a collimator lens 4, a prism mirror 5, an objective lens 6, an optical disk 7a for a CD-R, a thin optical disk 7b for a DVD, a monitor detector 8, and a wavelength-selective aperture plate 11.

The hologram-detector combination laser unit 1 for a CD-R has a first light source A as a semiconductor laser for a CD-R, and has a detector which emits a light beam as a divergent light as well as receives a light beam reflected from the optical disk 7a, also serving as a detecting means. Since the optical disk 7a is in the form of a CD-R, wavelength λ1 of the light beam emitted from the first light source A is 760 nm≦λ1≦810 nm.

The hologram-detector combination laser unit 2 for a DVD has a second light source B as a semiconductor laser for a DVD, and has a detector which emits a light beam as a divergent light with emission wavelength different from that of the first light source as well as receives a light beam reflected from the optical disk 7b, and serves as a detecting means too. Since the optical disk 7b is in the form of a DVD, wavelength λ2 of the light beam emitted from the second light source B is 620 nm≦λ2≦680 nm.

The beam splitter 3 is a synthesizing means for making an optical axis of the light beam emitted from the first light source coincide with an optical axis of the light beam emitted from the second light source.

The collimator lens 4 converts light beams as divergent lights emitted from the first and second light sources A and B into parallel lights.

The prism mirror 5 is a light path length converting means for lengthening light path length.

The objective lens 6 is a converging means for converging respective light beams outputted from the beam splitter 3 as a synthesizing means onto the optical disks 7a and 7b.

Reference numeral 7a is an optical disk in the form of a CD-R with 1.2 mm base material thickness and 7b is an optical disk in the form of a DVD with 0.6 mm base material thickness.

The monitor detector 8 controls outputs of the light beams emitted from the first and second light sources A and B.

The wavelength-selective aperture plate 11 is a wavelength-selective aperture which moves with the objective lens as a converging means so as to converge light beam spots of desired sizes onto the optical disks 7a and 7b.

Next, an operation of the so-constructed optical pickup will be described.

A light beam with wavelength λ1 (760 nm≦λ1≦810 nm) emitted from the semiconductor laser for a CD-R as the first light source A in the hologram-detector combination laser unit 1 for a CD-R is transmitted through the beam splitter 3, is emitted from the collimator lens 4 as a divergent light, is reflected on the surface of the prism mirror 5, passes through the wavelength-selective aperture plate 11 being capable of moving with the objective lens, is converged at the objective lens 6, and forms a desired optical spot on a recording surface of the optical disk 7a for a CD-R.

Next, the light beam reflected on the recording surface of the optical disk 7a passes through the objective lens 6 and the wavelength-selective aperture plate 11 again, is reflected on the surface of the prism mirror 5, passes through the collimator lens 4, is transmitted through the beam splitter 3, and is detected at the detector of the hologram-detector combination laser unit 1 for a CD-R. Focus detection can be performed by well-known methods such as a SSD method and a knife-edge method, and track detection can be performed by a 3-beam method or a push-pull method.

On the other hand, like the first light source A, a light beam with wavelength λ2 (620 nm≦λ2≦680 nm) emitted from the semiconductor laser 2 for a DVD as the second light source B in the hologram-detector combination laser unit 2 for a DVD is reflected at the beam splitter 3, so as to approximately coincide with an optical axis of the light beam from the first light source. Thereafter, the light beam is converted to parallel light beam by the collimator lens 4, is reflected on the surface of the prism mirror 5, and thereafter it passes through the wavelength-selective aperture plate 11, is converged at the objective lens 6, and forms a desired optical spot on a recording surface of the thin optical disk 7b for a DVD.

Next, the light beam reflected on the recording surface of the thin optical disk 7b passes through the objective lens 6 and the wavelength-selective aperture plate 11 again, is reflected on the surface of the prism mirror 5, passes through the collimator lens 4, is reflected at the beam splitter 3, and is detected at the detector of the hologram-detector combination laser unit 2 for a DVD.

As described above, in the optical pickup device according to the first embodiment, the prism mirror 5 as a light path length converting means for lengthening light path length (air reduction length) is provided between the beam splitter 3 as a synthesizing means and the objective lens 6 as a converging means, so that the synthesizing means and the converging means can be made close to each other, and a compact design of the optical system itself is possible, whereby downsizing, weight saving, and thinning of the optical pickup device can be realized, random access and degree of mechanical freedom of the loading system are improved, and weight saving of a drive can be realized.

Further, the beam splitter 3 as a synthesizing means is made closer to the objective lens 6 as a converging means as well as the position of the first light source A is corrected so as to improve converging degree on the recording surface of the optical disk 7a sufficiently enough for recording and reproduction, and therefore imaging magnification M1 accomplished by each optical element in a CD-R light path can be made smaller than imaging magnification M2 in a DVD light path (1.5≦M2/M1), and it is possible to enhance utilizing efficiency of light beams as well as secure sufficient quantity of converged light for high-speed recording.

Further, light beams as divergent lights emitted from the first and second light sources A and B are incident on the beam splitter 3 as a synthesizing means, whereby a reflected light on the surface of the beam splitter 3 is scattered, so that interference between the light beams emitted from the first and second light sources A and B, and a returned light from the optical disk can be reduced.

While a description has been given of the first embodiment which employs the prism mirror 5 as a light path length converting means for lengthening light path length of lights, the light path length converting means is not restricted thereto, and anything, such as one employing material having high refractive index for internal reflection, can be employed as long as it lengthens light path length of lights.

### EMBODIMENT 2

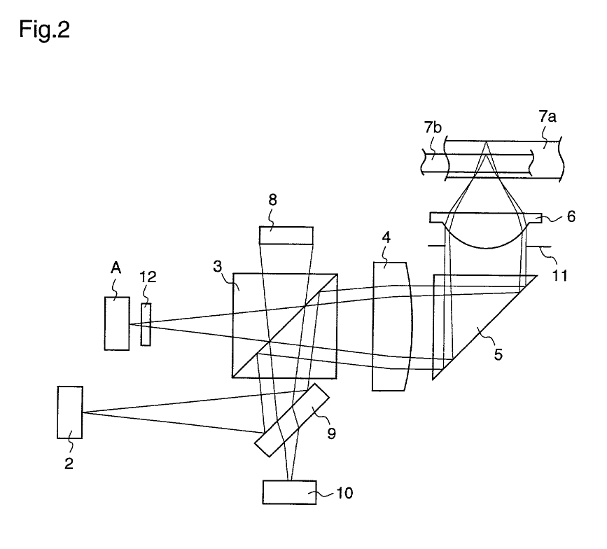

Hereinafter, an optical pickup device according to a second embodiment of the present invention will be described with reference to FIG. 2.

FIG. 2 is a schematic diagram exemplifying the optical pickup device according to the second embodiment of the present invention.

In the figure, the optical pickup device according to the second embodiment of the present invention comprises a first light source A, a hologram-detector combination mold laser unit 2 for a DVD, a beam splitter 3, a collimator lens 4, a prism mirror 5, an objective lens 6, an optical disk 7a for a CD-R, a thin optical disk 7b for a CD-R, a monitor detector 8, a wavelength-selective flat plate 9, a detector 10, a wavelength-selective aperture plate 11, and a diffraction grading 12.

The optical pickup device according to the second embodiment differs from the optical pickup device according to the aforementioned first embodiment only in the point that a hologram-detector combination laser unit for a CD-R is not employed.

Thus, the same components as those in the optical pickup device according to the aforementioned first embodiment are denoted by the same reference numerals, and their descriptions will be omitted.

The wavelength-selective flat plate 9 is a means for reflecting a light beam emitted form a second light source B held by the hologram-detector combination laser unit 2 for a DVD as well as a light beam from the second light source B reflected from the optical disk 7b and transmitting a light beam from the first light source A reflected from the optical disk 7a.

The detector 10 is a detecting means for receiving a light beam from the first light source A reflected from the optical disk 7a.

The diffraction grading 12 diffracts a light beam emitted from a semiconductor laser for a CD-R as the first light source A.

Next, an operation of the so-constructed optical pickup device according to the second embodiment will be described.

A light beam with wavelength λ1 (760 nm≦λ1≦810 nm) emitted from the semiconductor laser for a CD-R as the first light source A is diffracted by the diffraction grading 12, is transmitted through the beam splitter 3, is emitted from the collimator lens 4 as a divergent light, is reflected on the surface of the prism mirror 5, passes through the wavelength-selective aperture plate 11, is converged at the objective lens 6, and forms a desired optical spot on a recording surface of the optical disk 7a for a CD-R.

Next, the light beam reflected on the recording surface of the optical disk 7a passes through the objective lens 6 and the wavelength-selective aperture plate 11 again, is reflected on the surface of the prism mirror 5, passes through the collimator lens 4, is reflected at the beam splitter 3, is further transmitted through the wavelength-selective flat plate 9, and is detected at the detector 10. At this time, focus detection can be performed by well-known methods such as an astigmatism method and a knife-edge method, and track detection can be performed by a push-pull method or a 3-beam method.

On the other hand, like the first light source A, a light beam with wavelength λ2 (620 nm≦λ2≦680 nm) emitted from the second light source B held by the hologram-detector combination mold laser unit 2 for a DVD is reflected at the wavelength-selective flat plate 9, is further reflected at the beam splitter 3, so as to approximately coincide with an optical axis of the light beam from the first light source A. Thereafter, the light beam is converted to a parallel light beam by the collimator lens 4, is reflected on the surface of the prism mirror 5, and thereafter it passes through the wavelength-selective aperture plate 11, is converged at the objective lens 6, and forms a desired optical spot on a recording surface of the thin optical disk 7b for a DVD.

Next, the light beam reflected on the recording surface of the thin optical disk 7b passes through the objective lens 6 and the wavelength-selective aperture plate 11 again, is reflected on the surface of the prism mirror 5, passes through the collimator lens 4, is reflected at the beam splitter 3, is further reflected at the wavelength-selective flat plate 9, and is detected at a detector part in the hologram-detector combination mold laser unit 2 for a DVD having the second light source B.

As described above, in the optical pickup device according to the second embodiment, the prism mirror 5 as a light path length converting means for lengthening light path length (air reduction length) is provided between the beam splitter 3 as a synthesizing means and the objective lens 6 as a converging means, so that the synthesizing means can be made close to the converging means and a compact design of the optical system itself is possible, whereby downsizing, weight saving, and thinning of the optical pickup device can be realized, random access and degree of mechanical freedom of the loading system are improved, and weight saving of a drive can be realized.

Further, the beam splitter 3 as a synthesizing means is made closer to the objective lens 6 as a converging means as well as the position of the first light source A is corrected so as to improve converging degree on the recording surface of the optical disk 7a sufficiently enough for recording and reproduction, and therefore imaging magnification M1 accomplished by each optical element in a CD-R light path can be made smaller than imaging magnification M2 in a DVD light path (1.5≦M2/M1), and it is possible to enhance utilizing efficiency of light beams as well as secure sufficient quantity of converged light for high-speed recording.

While a description has been given of the second embodiment which employs the prism mirror 5 as a light path length converting means for lengthening light path length of lights, the light path length converting means is not restricted thereto, and anything, such as one employing material having high refractive index for internal reflection, can be employed as long as it lengthens light path length of lights.

Further, light beams as divergent beams emitted from the first and second light sources A and B are incident on the beam splitter 3 as a synthesizing means, whereby a reflected light on the surface of the beam splitter 3 is scattered, so that interference between the light beams emitted from the first and second light sources A and B and a returned light from the optical disk can be reduced.

### EMBODIMENT 3

Hereinafter, an optical pickup device according to a third embodiment of the present invention will be described with reference to FIG. 1.

FIG. 1 is a schematic diagram exemplifying the optical pickup device according to the third embodiment of the invention.

In FIG. 1, the first light source A in the hologram-detector combination laser unit 1 for a CD-R is located nearer to the collimator lens 4 than a back focus f1 thereof is and the second light source B in the hologram-detector combination laser unit 2 for a DVD is located farther from the collimator lens 4 than a back focus f2 thereof is.

Other constructions of the optical pickup device according to the third embodiment are the same as those of the optical pickup device according to the first embodiment, and their descriptions will be omitted.

Hereinafter, an operation of the optical pickup device according to the third embodiment will be described with reference to FIG. 1.

As shown in FIG. 1, a light beam emitted from the semiconductor laser for a CD-R as the first light source A in the hologram-detector combination laser unit 1 for a CD-R is first transmitted through the beam splitter 3, is converted into a weak divergent light to a parallel light by the collimator lens 4, is reflected on the surface of the prism mirror 5, passes through the aperture plate 11, is converged at the objective lens 6, and forms a desired optical spot on a recording surface of the optical disk 7a for a CD-R. Next, the light beam reflected on the recording surface of the optical disk 7a passes through the objective lens 6 and the aperture plate 11 again, is reflected on the surface of the prism mirror 5, passes through the collimator lens 4, is transmitted through the beam splitter 3, and is detected at a detector part of the laser unit 1 for a CD-R. Focus detection can be performed by well-known methods such as a SSD method and a knife-edge method, and track detection can be performed by a 3-beam method or a push-pull method.

As shown in FIG. 1, like the first light source, a light beam emitted from the semiconductor laser 2 for a DVD as the second light source in the hologram-detector combination laser unit 2 is reflected at the beam splitter 3, so as to approximately coincide with an optical axis of the light beam from the first light source. Thereafter, the light beam is emitted from the collimator lens 4 as a parallel light to a weak converged light, is reflected on the surface of the prism mirror 5, passes through the wavelength-selective aperture plate 11 being capable of moving with the objective lens 6, is converged at the objective lens 6, and forms a desired optical spot on a recording surface of the thin optical disk 7b for a DVD. Next, the light beam reflected on the recording surface of the thin optical disk 7b passes through the objective lens 6 and the wavelength-selective aperture plate 11 again, is reflected on the surface of the prism mirror 5, passes through the collimator lens 4, is reflected again at the beam splitter 3, and is detected at a detector part of the hologram-detector combination laser unit 2 for a DVD.

As described above, in the optical pickup device according to the third embodiment, when recording/reproduction onto/from the optical disk 7a for a CD-R and the thin optical disk 7b for a DVD is performed through the respective light paths, the semiconductor laser 1 for a CD-R is located nearer to the collimator lens 4 than the back focus thereof is and the semiconductor laser 2 for a DVD is located farther from the collimator lens 4 than the back focus thereof is, while light path length (air reduction length) between the beam splitter 3 and the objective lens 6 is made shorter by the use of the prism mirror 5 or the like, and when imaging magnification that is accomplished by an optical element between the semiconductor laser 1 for a CD-R and the optical disk 7a is made M1 and imaging magnification that is accomplished by an optical element between the semiconductor laser 2 for a DVD and the optical disk 7b is made M2, an optical construction is taken so as to satisfy the conditional expression (1).

1.5≦M2/M1 (1)

Then, accordingly, positions of the laser unit 1 for a CD-R and laser unit 2 for a DVD are corrected so that the desired optical spots can be formed on the information recording surfaces of the optical disks 7a and 7b, thereby increasing the imaging magnification M2 that is accomplished by each optical element in a DVD optical system, while decreasing the imaging magnification M1 that is accomplished by each optical element in a CD-R optical system. This is because imaging magnification is required to be increased so as to be advantageous to the reproduction of DVD-RAM or the like in the DVD optical system, while the imaging magnification is required to be decreased in order to increase quantity of converged light on the recording surface of the optical disk in the CD-R optical system.

Further, when imaging magnification of the objective lens 6 with respect to the semiconductor laser 1 is made m1, by satisfying the conditional expression (2), the CD-R optical system is made to have finite conjugate configuration much closer to infinite conjugate configuration, so that it is not likely to cause a state change of an incident light which is input into the objective lens 6 by lens shifting.

|m1|≦0.068 (2)

Furhter, an optical system having a larger numerical aperture is weak to a tilt of an optical disk, and therefore, when numerical aperture on the side of the optical disk 7a corresponding to the combination of the semiconductor laser 1 for a CD-R and the optical disk 7a in the form of a CD-R is supposed to be NA1, and numerical aperture on the side of the thin optical disk 7b corresponding to the combination of the semiconductor laser 2 for a DVD and the thin optical disk 7b in the form of a DVD is supposed to be NA2, the CD-R optical system and the DVD optical system come into a relation satisfying the conditional expression (3).

NA1<NA2 (3)

Accordingly, since the DVD optical system is desired to have configuration much closer to that of an infinite conjugate type in the CD-R optical system and the DVD optical system having the relationship of the conditional expression (3), when imaging magnification of the objective lens 6 with respect to the semiconductor laser 1 for a CD-R is made m1 and imaging magnification of the objective lens 6 with respect to the semiconductor laser 2 for a DVD is made m2, the following conditional expression (4) is satisfied.

|m2|≦|m1| (4)

As described above, in the optical pickup device according to the third embodiment, which comprises the first light source (the semiconductor laser 1 for a CD) and the second light source (the semiconductor laser 2 for a DVD) which emit light beams with different wavelength, corresponding to the optical disk 7a in the form of a CD-R and the optical disk 7b in the form of a DVD, the collimator lens 4, and the objective lens 6, the semiconductor laser 2 for a DVD is located farther from the collimator lens 4 than the back focus thereof is, while the semiconductor laser 1 for a CD is located nearer to the collimator lens 4 than the back focus thereof is, and the distance between the collimator lens 4 and the objective lens 6 is made closer, thereby increasing imaging magnification that is accomplished by an optical element in the DVD optical system, while decreasing imaging magnification that is accomplished by an optical element in the CD-R optical system, resulting in imaging magnification required for respective optical systems being obtained.

Further, the CD-R optical system is made finite conjugate configuration much closer to infinite conjugate configuration, and therefore the both optical systems are approximate to the infinite conjugate configuration, thereby suppressing performance degradation at the lens shift.

### APPLICABILITY IN INDUSTRY

As described above, an optical pickup device according to the present invention is suited to perform recording and reproduction onto/from plural kinds of optical disks.

Claims

1. An optical pickup device comprising:
a first light source for emitting a light beam with arbitrary wavelength; a second light source for emitting a light beam with wavelength different from that of the first light source;
a synthesizing means for making an optical axis of the light beam emitted from the first light source coincide with an optical axis of the light beam emitted from the second light source;
a converging means for converging the light beam outputted from the synthesizing means onto an optical disk; and
a detecting means for receiving the light beam reflected on the optical disk, wherein
the synthesizing means is made close to the converging means, so as to drastically change imaging magnification as divergence degree of the light beam emitted from the first light source, which is outputted from the synthesizing means and imaging magnification as divergence degree of a light source of the light beam emitted from the second light source, which is outputted from the synthesizing means.

2. The optical pickup device as defined in claim 1 including:
a converting means for converting the light beam outputted from the synthesizing means into parallel lights.

3. The optical pickup device as defined in claim 2, wherein
when a back focus of the converting means for the wavelength of the first light source is f1 and a back focus of the converting means for the wavelength of the second light source is f2, the first light source is located at a position nearer to the converting means than f1 is, while the second light source is located at a position farther from the converting means than f2 is.

4. The optical pickup device as defined in any of claims 1 to 3, wherein
a light path length converting means for lengthening light path length of a light is provided between the synthesizing means and the converging means.

5. The optical pickup device as defined in claim 4, wherein
the light path length converting means is made of material having high refractive index.

6. The optical pickup device as defined in any of claims 1 to 5, wherein
when imaging magnification that is accomplished by an optical element between the first light source and the optical disk is made M1 and imaging magnification that is accomplished by an optical element between the second light source and the optical disk is made M2, 1.5≦M2/M1.

7. The optical pickup device as defined in any of claims 1 to 6 further including:
an aperture diaphragm for moving with the converging means and converging a light beam spot of desired size onto the optical disks.

8. The optical pickup device as defined in any of claims 1 to 7, wherein
when imaging magnification of the converging means with respect to the first light source is made m1, the following conditional expression is satisfied:

|m1|≦0.068.

9. The optical pickup device as defined in any of claims 1 to 8, wherein
when numerical aperture on the side of the optical disk corresponding to the combination of the first light source and the optical disk is made NA1, and numerical aperture on the side of the optical disk corresponding to the combination of the second and the optical disk is made NA2, and
when the imaging magnification of the converging means with respect to the first light source is made m1, and imaging magnification of the converging means with respect to the second light source is made m2, the following conditional expressions are satisfied:
NA1<NA2,

|m2|≦|m1|.

10. The optical pickup device as defined in any of claims 1 to 9, wherein
when wavelength of the light beam emitted from the first light source is made λ1, and wavelength of the light beam emitted from the second light source is made λ2,
760 nm≦λ1≦810 nm,
620 nm≦λ2≦680 nm.

11. The optical pickup device as defined in any of claims 1 to 10, wherein
the light beams as divergent lights emitted from the first and second light sources are incident on the synthesizing means, thereby scattering a reflected light on the surface of the synthesizing means.
